(19) United States
(12) Patent Application Publication
(10) Pub. No.: US 2025/0156734 A1
(43) Pub. Date: May 15, 2025

(54) SAFETY COMPLIANCE FOR VIRTUALIZED AUTOMOTIVE COMPUTING

(71) Applicant: Red Hat, Inc., Raleigh, NC (US)

(72) Inventors: Leigh Griffin, Waterford (IE); Diana Puodziunaite, Farnborough (GB)

(21) Appl. No.: 18/388,675

(22) Filed: Nov. 10, 2023

(51) Int. Cl. G06N 5/022; G06F 9/455

(52) U.S. Cl. CPC G06N 5/022; G06F 9/45558; G06F 2009/45591

(57) ABSTRACT

Systems, methods, and apparatuses for maintaining safety standard compliance in virtualized automotive computing systems are provided herein. An example method comprises monitoring an automotive computing environment executing a plurality of virtual machines, responsive to a request to instantiate a new virtual machine, inspecting a configuration file of the new virtual machine, responsive to a configuration parameter of the configuration file violating a first predefined safety rule, modifying the configuration parameter, monitoring communications to and from a virtual machine of the plurality of virtual machines, the monitored communications including a first communication, and responsive to the first communication violating a second predefined safety rule, modifying a parameter of the automotive computing environment, or intercepting the first communication and modifying a content of the first communication.

### BACKGROUND

Many automotive systems employ computers to monitor conditions, make decisions, and provide entertainment. Safety standards are often provided and/or mandated for automotive components that perform safety-critical functions. These safety standards often require performance guarantees from computing systems. Virtual computing may involve executing one or more virtual machines on a host system in order to perform tasks.

### SUMMARY

Systems, methods, and apparatuses are provided for maintaining safety standard compliance in virtualized automotive computing systems. In an example, a method comprises monitoring an automotive computing environment executing a plurality of virtual machines, responsive to a request to instantiate a new virtual machine, inspecting a configuration file of the new virtual machine, responsive to a configuration parameter of the configuration file violating a first predefined safety rule, modifying the configuration parameter, monitoring communications to and from a virtual machine of the plurality of virtual machines, the monitored communications including a first communication, and responsive to the first communication violating a second predefined safety rule, modifying a parameter of the automotive computing environment, or intercepting the first communication and modifying a content of the first communication.

In another example, a system comprises a memory and a processing device, operatively coupled to the memory, to monitor an automotive computing environment executing a plurality of virtual machines, responsive to a request to instantiate a new virtual machine, inspect a configuration file of the new virtual machine, responsive to a configuration parameter of the configuration file violating a first predefined safety rule, modify the configuration parameter, monitor communications to and from a virtual machine of the plurality of virtual machines, the monitored communications including a first communication, and responsive to the first communication violating a second predefined safety rule, modify a parameter of the automotive computing environment, or intercept the first communication and modify a content of the first communication.

In yet another example, a non-transitory computer-readable medium stores instructions which, when executed by a processing device, cause the processing device to monitor an automotive computing environment executing a plurality of virtual machines, responsive to a request to instantiate a new virtual machine, inspect a configuration file of the new virtual machine, responsive to a configuration parameter of the configuration file violating a first predefined safety rule, modify the configuration parameter, monitor communications to and from a virtual machine of the plurality of virtual machines, the monitored communications including a first communication, and responsive to the first communication violating a second predefined safety rule, modify a parameter of the automotive computing environment, or intercept the first communication and modify a content of the first communication.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the Figures and the Detailed Description. Moreover, it should be noted that the language used in this specification has been principally selected for readability and instructional purposes, and not to limit the scope of the inventive subject matter.

### BRIEF DESCRIPTION OF THE DRAWINGS

The description will be more fully understood with reference to the following figures, which are presented as exemplary aspects of the disclosure and should not be construed as a complete recitation of the scope of the disclosure, wherein:

FIG. 1 illustrates an example computing system, according to example embodiments of the present disclosure.

FIG. 2 illustrates an example method for maintaining safety standard compliance in an automotive computing environment, according to example embodiments of the present disclosure.

FIG. 3A and FIG. 3B illustrate an example sequence of events in an automotive computing environment, according to example embodiments of the present disclosure.

FIG. 4 illustrates an example method for training and using a machine learning model in an automotive computing environment, according to example embodiments of the present disclosure.

FIG. 5 illustrates an example communication diagram for an automotive computing environment, according to example embodiments of the present disclosure.

### DETAILED DESCRIPTION

Techniques are disclosed herein for maintaining safety standard compliance in virtualized automotive computing systems. Automotive computing systems are increasingly being expected to perform tasks which affect vehicle safety. Particularly, driver assistance and collision avoidance functions such as, but not limited to automatic lane keeping, active cruise control, and active braking may share computational resources with navigation functions, entertainment systems, and other various processes within a vehicle. Those skilled in the art will recognize that separation and prioritization of safety critical functions from less important functions like entertainment is desirable, but this is often more difficult than it appears. Hardware separation (i.e. having a physical computing system for safety critical processes separate from a navigation or entertainment computing system) may initially seem like an attractive option, but this is resource intensive when scaled to an entire production run of automobiles, and can add expense and complexity to a manufacturing process.

Embodiments of the present disclosure accomplish this separation without the use of hardware separation. A dynamic safety handler can be configured to oversee a virtualized automotive computing environment, ensuring that safety-related virtual machines are prioritized for resource allocation. The dynamic safety handler may also monitor communications between virtual machines as well as to and from the virtualized automotive computing environment to ensure that sensitive information is not shared with external entities, and may monitor initializations of additional virtual machines to ensure that configurations of those machines adhere to safety rules. In this way, advantages associated with shared hardware, such as better resource utilization, can be maintained while mitigating performance risks and upholding safety standards.

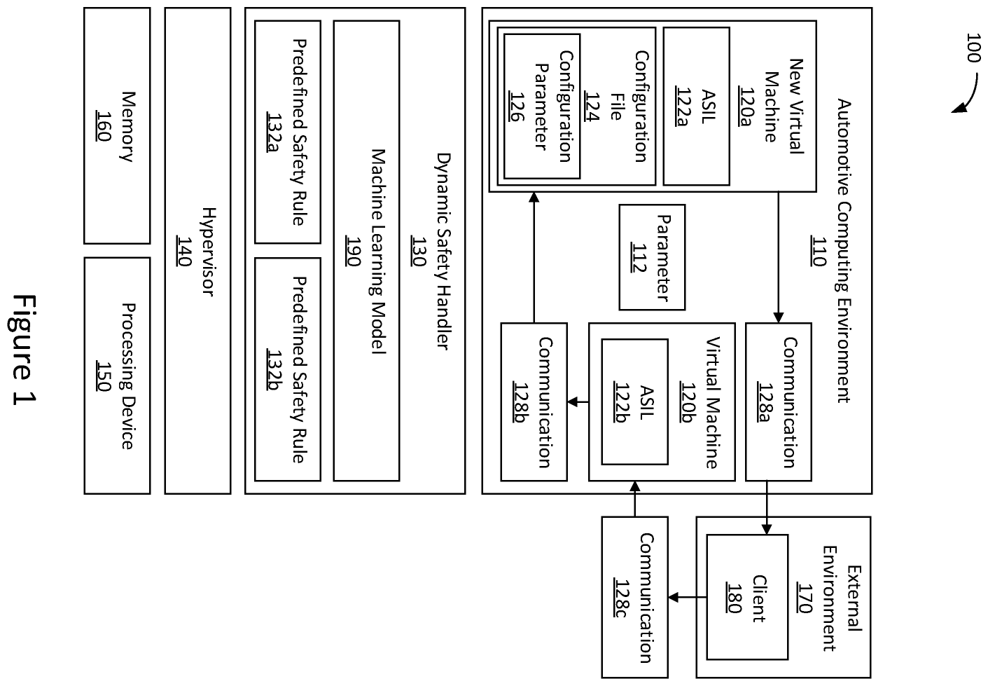

FIG. 1 illustrates an example computing system 100, according to example embodiments of the present disclosure. An automotive computing environment 110 is managed by a dynamic safety handler 130, executing on a hypervisor 140 which in turn executes on a processing device 150. The processing device 150 may be in communication with a memory 160. The dynamic safety handler may reference a first predefined safety rule 132a and a second predefined safety rule 132b. These predefined safety rules may be extended to any arbitrary number, and may be held in the memory 160 or a storage. The dynamic safety handler 130 may include a machine learning model 190 which may monitor the automotive computing environment 110 and cause the dynamic safety handler 130 to take actions to manage the automotive computing environment 110.

The automotive computing environment 110 may instantiate a new virtual machine 120a. This new virtual machine 120a may have a configuration parameter 126 within a configuration file 124 which may be monitored by the dynamic safety handler 130 before the new virtual machine 120a begins execution. The new virtual machine 120a may have an associated first Automotive Safety Integrity Level 122a (first ASIL 122a) which may indicate to the dynamic safety handler 130 to what degree the new virtual machine 120a is safety-critical. The dynamic safety handler 130 may make decisions regarding resource allocations, communications, and instantiation requests of the new virtual machine 120a based upon this ASIL 122a value. Responsive to a determination that a safety rule (e.g. the first predefined safety rule 132a) is being violated or is about to be violated, the dynamic safety handler 130 may alter a parameter 112 of the automotive computing environment 110. For example, responsive to a determination that, after instantiation, the new virtual machine 120a required additional allocation of the memory 160 and that the first ASIL 122a is of higher importance than ASILs of other virtual machines executing in the automotive computing environment 110, the dynamic safety handler may alter a parameter 112 which determines memory 160 allocation ratios between virtual machines of the automotive computing environment 110 to allocate more of the memory 160 to the new virtual machine 120a.

The new virtual machine 120a, once instantiated, may send a first communication 128a (which may or may not be the first communication sent by the new virtual machine 120a) to a client 180 in an external environment 170. The client 180 may be any entity which may be expected to communicate with the new virtual machine 120a, including but not limited to roadside devices such as traffic light controllers, global positioning satellites, internet service providers, or other automotive computing environments. An existing virtual machine 120b which also may have a corresponding second ASIL 122b value may send a second communication 128b to the new virtual machine 120a. The client 180 (or a different client 180) may also send a third communication 128c to the existing virtual machine 120b. The dynamic safety handler 130 may monitor the first communication 128a, the second communication 128b, and the third communication 128c to determine whether a safety or security rule requires alteration of a respective communication. For example, a determination that the first communication 128a should be altered may be based partially or wholly upon the first ASIL 122a, may be based partially or wholly upon an identity of the client 180, and may also be based partially or wholly upon the first predefined safety rule 132a.

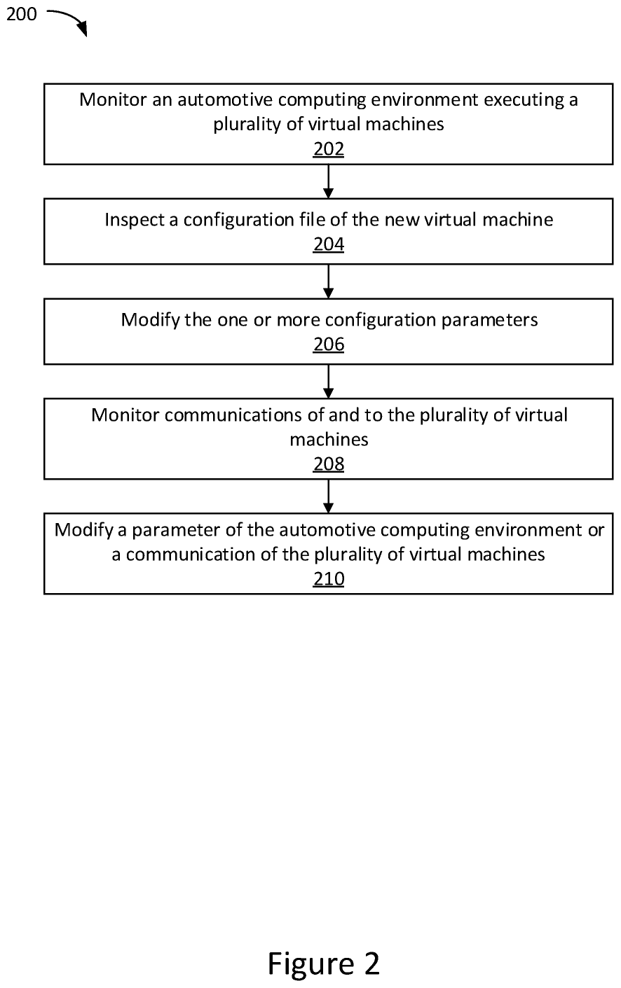

FIG. 2 illustrates an example method 200 for maintaining safety standard compliance in an automotive computing environment, according to example embodiments of the present disclosure. Although the example method 200 is described with reference to the flowchart illustrated in FIG. 2, it will be appreciated that many other methods of performing the acts associated with the method 200 may be used. For example, the order of some of the blocks may be changed, certain blocks may be combined with other blocks, one or more blocks may be repeated, and some of the blocks described are optional. The method 200 may be performed by processing logic that may comprise hardware (circuitry, dedicated logic, etc.), software, or a combination of both.

At block 202, an example dynamic safety handler monitors an automotive computing environment executing a plurality of virtual machines. For example, the dynamic safety handler 130 may monitor communications, resource allocations, and resource consumption of an existing virtual machine 120b of the automotive computing environment 110. The existing virtual machine 120b may be configured to turn automatic headlights on and off in response to changes in external lighting conditions, for example. The dynamic safety handler 130 may also monitor a configuration file 124 associated with an instantiation request for a new virtual machine 120a for controlling an active cruise control system. The method 200 then proceeds to block 204.

At block 204, the example dynamic safety handler inspects a configuration file of the new virtual machine. For example, the dynamic safety handler 130 may, responsive to an instantiation request for the new virtual machine 120a, inspect a plurality of configuration parameters of a configuration file 124 to ensure that none of the configuration parameters (such as initial memory 160 allocation, processing capacity requirements, network access configurations, required software dependencies, etc.) violates any of a plurality of predefined safety rules. The dynamic safety handler 130 may also consult a reference database, either remote or local, to determine whether configuration parameters of the new virtual machine 120a are within expected bounds for active cruise control virtual machines. The method 200 then proceeds to block 206.

At block 206, the example dynamic safety handler modifies one or more configuration parameters. For example, the dynamic safety handler 130 may determine that a configuration parameter 126 which sets access control permissions for the new virtual machine 120a is set to allow the new virtual machine 120a to access a dependency which can perform restricted tasks in excess of what is typically required of an active cruise control virtual machine, such as accessing steering data. The dynamic safety handler 130 may then modify the configuration parameter 126, responsive to the determination, to ensure that the new virtual machine 120a does not have access to unnecessary systems that may impact safety. For example, the dynamic safety handler 130 may alter the configuration parameter 126 to cause execution of a new instance of the dependency with more restrictive access permissions. The dynamic safety handler 130 may record this change and may automatically perform the change for future instantiations of the new virtual machine 120a.

In some embodiments, the configuration file 124 may be saved after modification by the dynamic safety handler 130, and inspection of the configuration file 124 may be abbreviated or nonexistent for future instantiations of the new virtual machine 120a. A skipped inspection of the configuration file 124 may be dependent on verification that the configuration file 124 has not changed since a last instantiation of the new virtual machine 120a. For example, the dynamic safety handler 130 may hash the configuration file 124 and store a hashed value. When a future request to instantiate the new virtual machine 120a is received, the dynamic safety handler 130 may hash the configuration file 124 again and compare a result with the stored value, skipping further inspection when the stored value matches the result. The method 200 then proceeds to block 208.

At block 208, the example dynamic safety handler monitors communications of and to the plurality of virtual machines. For example, the dynamic safety handler 130 may intercept a first communication 128a between the new virtual machine 120a and a traffic reporting server (i.e. a client 180 in an external environment 170) containing average speed data from the active cruise control system. The dynamic safety handler 130 may intercept an attempted second communication 128b which contains a webpage request from an existing virtual machine 120b which runs an entertainment system (and which has been somehow misconfigured such that it is sending communications to incorrect recipients) and the new virtual machine 120a. The dynamic safety handler 130 may also intercept a third communication 128c containing audio streaming data between a media server (i.e. another client 180 in the external environment 170) and the existing virtual machine 120b. The method 200 then proceeds to block 210.

At block 210, the example dynamic safety handler modifies a parameter of the automotive computing environment or a communication of the plurality of virtual machines. For example, the dynamic safety handler 130 may remove geographical data from the first communication 128a responsive to a determination that the geographical data is sensitive and that inclusion of the geographical data in the first communication 128a violates at least one safety rule. The dynamic safety handler 130 may reconfigure the existing virtual machine 120b to address website requests to a proper port (either by altering a configuration parameter of the existing virtual machine 120b or by modifying a parameter 112 of the automotive computing environment 110 which determines how communications of the existing virtual machine 120b are routed). Additionally, the dynamic safety handler 130 may determine that a volume of communications between the media server and the existing virtual machine 120b has elevated latency levels for the new virtual machine 120a above an acceptable quality of service benchmark. As a result, the dynamic safety handler 130 may restrict a network bandwidth of the existing virtual machine 120b to reduce a volume of communications of the existing virtual machine 120b. Responsive to a subsequent decrease in network communication demand, the dynamic safety handler 130 may relax the bandwidth restriction.

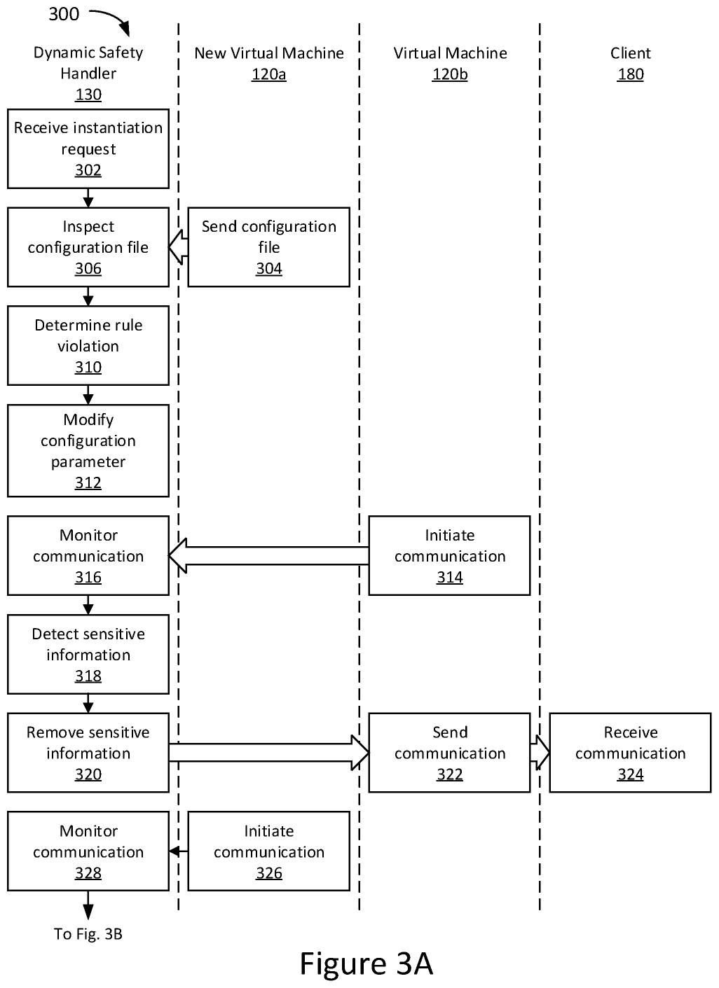

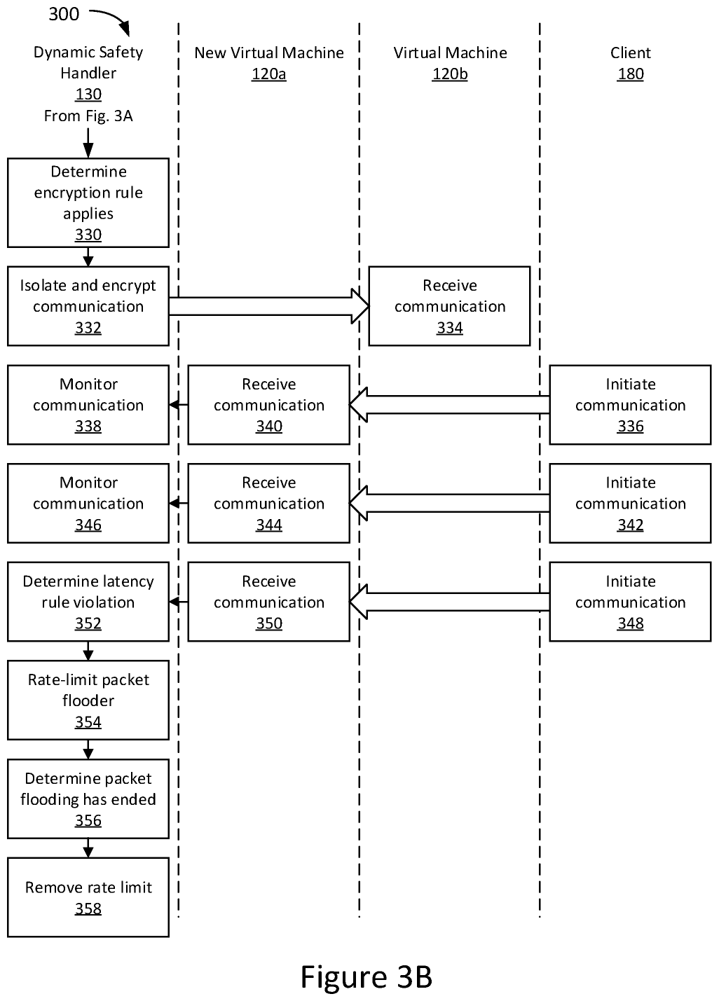

FIG. 3A and FIG. 3B illustrate an example sequence of events 300 in an automotive computing environment 110, according to example embodiments of the present disclosure. It will be appreciated that the events illustrated in FIG. 3A and FIG. 3B appear as an exemplary sequence of events, and that in practice any of these events may happen in any order. It will also be appreciated that some or all of these events may not occur during a given period of operation of an embodiment of the present disclosure, and that additional events not illustrated herein may also occur.

In an automotive computing environment 110, a dynamic safety handler 130 receives an instantiation request 302 for a new virtual machine 120a for managing a lane assist feature with a first ASIL 122a. The dynamic safety handler 130 retrieves 304 a configuration file 124 associated with the new virtual machine 120a, and inspects 306 the configuration file 124 for violations of one or more predefined safety rules. The dynamic safety handler 130 determines 310 that a first predefined safety rule 132a specifying which ports are allowed to be open on virtual machines with the first ASIL 122a is violated by a configuration parameter 126 within the configuration file 124 specifying which ports are to be open upon instantiation of the new virtual machine 120a. The dynamic safety handler 130 may then modify 312 the configuration parameter 126 to prevent ports restricted by the first predefined safety rule 132a from being opened. The new virtual machine 120a may then be allowed to begin execution.

Separately, an existing virtual machine 120b which controls an active braking system may initiate 314 a first communication requesting a stoplight's state information to an external client 180 (e.g. a stoplight controller). The dynamic safety handler 130 may monitor 316 the first communication and detect 318 that the first communication includes information about resource limits and a runtime state of the existing virtual machine 120b (which may constitute sensitive information). The dynamic safety handler 130 may thus remove 320 the information about resource limits and the runtime state from the first communication before allowing the existing virtual machine 120b to send 322 a redacted first communication to the stoplight controller (the client 180). The stoplight controller then receives 324 the redacted first communication.

Meanwhile, the new virtual machine 120a may initiate 326 a second communication with the existing virtual machine 120b requesting information about a change in speed that is being caused by the active braking system. The dynamic safety handler 130 monitors 328 the second communication as well. Continuing in FIG. 3B, the dynamic safety handler 130 may determine 330, based upon a second predefined safety rule 132b, that due to a probable sensitivity of information sent via a communication channel between the lane assist and the active brakes, such a communication channel should be encrypted. The dynamic safety handler 130 therefore isolates and encrypts 332 all communications between the new virtual machine 120a and the existing virtual machine 120b. The existing virtual machine 120b receives 334 the second communication via the isolated and encrypted channel.

A nearby vehicle's computer may then initiate a third communication 336 with the new virtual machine 120a informing the lane assist system that an object is in the road ahead. The third communication is monitored 338 by the dynamic safety handler 130, and received 340 by the new virtual machine 120a. The nearby vehicle's computer may have a fault which causes the nearby vehicle's computer to repetitively broadcast the third communication, initiating 342 the third communication a second time which is received 344 by the new virtual machine 120a and monitored 346 by the dynamic safety handler 130. The nearby vehicle's computer may initiate 348 the third communication a third time. The third communication may be received 350 by the new virtual machine 120a, but the dynamic safety handler 130 may determine 352 that the nearby vehicle's computer is sending communications at a rate that will, if left unchecked, cause unacceptable latency in the new virtual machine 120a and/or any other virtual machines of the automotive computing environment 110.

The dynamic safety handler 130 may resolve this issue by rate limiting 354 an external communication channel with the nearby vehicle's computer, only allowing every fifth broadcast, for example, of the third communication to reach the new virtual machine 120a. After some time has elapsed, the nearby vehicle's computer may be physically too far away from the automotive computing environment 110 to continue sending the third communication to the new virtual machine 120a. The dynamic safety handler 130 may determine 356 that the nearby vehicle's computer is no longer flooding the new virtual machine 120a with communications, and may remove 358 the rate limit on the external communication channel, allowing normal correspondence with other vehicle's computers once again.

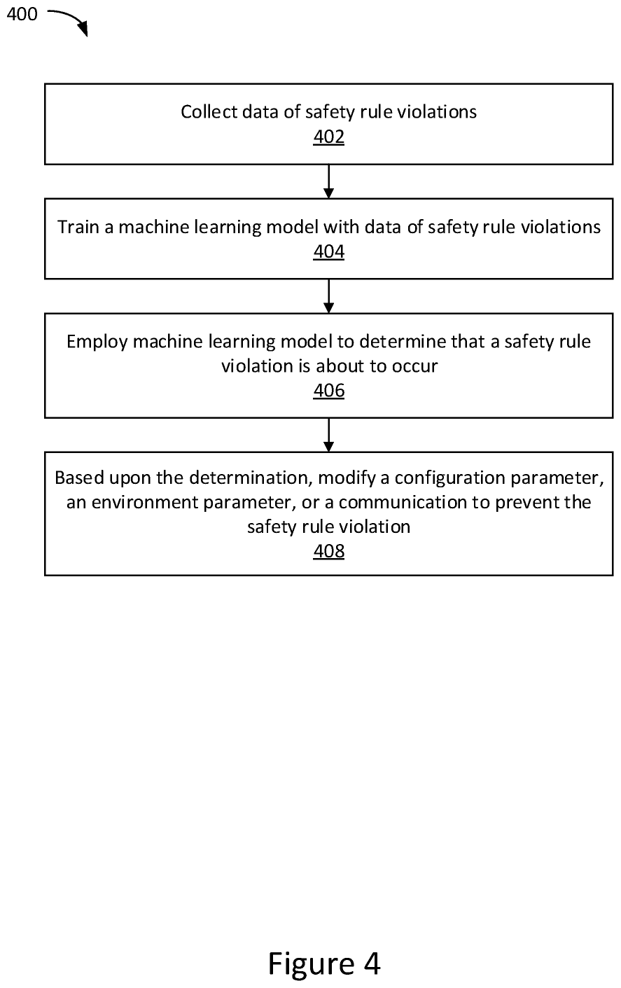

FIG. 4 illustrates an example method for training and using a machine learning model in an automotive computing environment, according to example embodiments of the present disclosure. Although the example method 400 is described with reference to the flowchart illustrated in FIG. 4, it will be appreciated that many other methods of performing the acts associated with the method 400 may be used. For example, the order of some of the blocks may be changed, certain blocks may be combined with other blocks, one or more blocks may be repeated, and some of the blocks described are optional. The method 400 may be performed by processing logic that may comprise hardware (circuitry, dedicated logic, etc.), software, or a combination of both.

At block 402, an example dynamic safety handler collects data about safety rule violations. For example, the dynamic safety handler 130 may save system state data from an automotive computing environment 110 every time a virtual machine for blind spot detection encounters unacceptable latency due to insufficient allocation of a memory 160. The state data may include data immediately preceding the event. The dynamic safety handler 130 may also feed this data directly into a training algorithm for a machine learning model. The dynamic safety handler 130 may also send statistics, including collected data, to an automobile manufacturer for amalgamation with data from other automotive computing environments. The method 400 then proceeds to block 404.

At block 404, the example dynamic safety handler trains a machine learning model with the data about the safety rule violations. For example, the dynamic safety handler 130 may employ a dataset including two-hundred instances of unacceptable latency events to train a neural net to recognize patterns surrounding the unacceptable latency events. The neural net may also be trained “on the fly”, being fed data in real-time to detect patterns in the data immediately preceding the unacceptable latency events. In some embodiments, a neural net may be trained at an automotive manufacturer from data collected from many automotive computing environments. A resulting machine learning model may then be loaded into the automotive computing environment 110. The method 400 then proceeds to block 406.

At block 406, the example dynamic safety handler employs the machine learning model to determine that a safety rule violation is about to occur. For example, the neural net may determine that unacceptable latency events often follow a rise in a communication volume of a navigation system. The neural net may then alert the dynamic safety handler 130 that an unacceptable latency event is likely upon detecting that the communication volume of the navigation system has risen according to previous patterns. The method 400 then proceeds to block 408.

At block 408, the example dynamic safety handler modifies a configuration parameter, an environment parameter, or a communication to prevent the safety rule violation. For example, when the dynamic safety handler 130 receives an alert from the neural net indicative of an impending unacceptable latency event, the dynamic safety handler 130 may rate limit the communication volume of the navigation system. What action is taken by the dynamic safety handler 130 may also be based upon a recommendation of the machine learning model. For example, the neural net may indicate to the dynamic safety handler 130 that the communication volume of the navigation system should be decreased to prevent the unacceptable latency event.

The dynamic safety handler 130 may begin acting upon recommendations from the neural net once the neural net reaches a predefined benchmark for accurately predicting unacceptable latency events. In embodiments where the neural net is centrally trained by the automotive manufacturer, the automotive computing environment 110 may receive updates to the neural net following additional training. In these embodiments, the dynamic safety handler 130 may immediately employ the updated neural net to determine whether an unacceptable latency event is imminent.

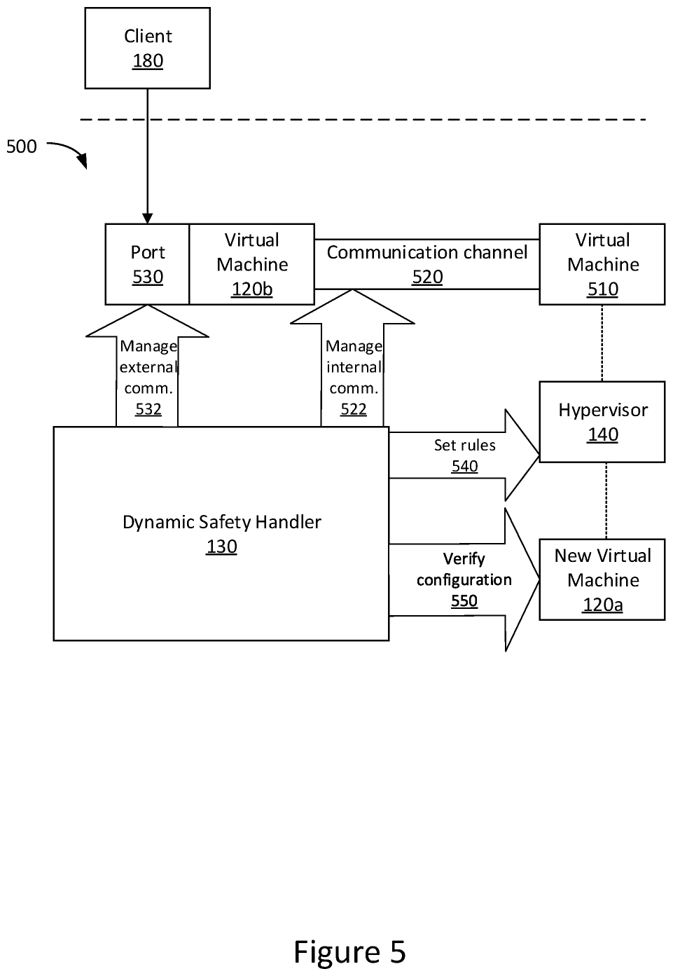

FIG. 5 illustrates an example communication diagram for an automotive computing environment 500, according to example embodiments of the present disclosure. A dynamic safety handler 130 may set rules 540 for a hypervisor 140, governing operating parameters, resource limits, relative priorities, and other parameters for the automotive computing environment 500. A new virtual machine 120a for monitoring emissions is instantiated in the automotive computing environment 500, and the dynamic safety handler 130 verifies 550 a configuration of the new virtual machine 120a before allowing execution of the new virtual machine 120a.

A first existing virtual machine 120b which determines an expected range before refueling communicates about a fuel burn rate with a second existing virtual machine 510 which controls fuel injection via a communication channel 520. The dynamic safety handler 130 manages 522 this internal communication, determining that the communication channel 520 should be encrypted and isolated to protect the sensitive information being exchanged.

The first existing virtual machine 120b also communicates externally with a client 180, a weather server providing wind speed and direction, via a port 530 to determine an effect of weather upon the expected range. The dynamic safety handler 130 manages 532 these communications, preventing the first existing virtual machine 120b from sending specific geographical location data to the weather server by redacting a city and road name, leaving a state name and a region identifier present.

It will be appreciated that all of the disclosed methods and procedures described herein can be implemented using one or more computer programs, components, and/or program modules. These components may be provided as a series of computer instructions on any conventional computer readable medium or machine-readable medium, including volatile or non-volatile memory, such as RAM, ROM, flash memory, magnetic or optical disks, optical memory, or other storage media. The instructions may be provided as software or firmware and/or may be implemented in whole or in part in hardware components such as infrastructure processing units (IPUs), graphical processing units (GPUs), data processing units (DPUs), ASICs, FPGAs, DSPs or any other similar devices. The instructions may be configured to be executed by one or more processors, which when executing the series of computer instructions, performs or facilitates the performance of all or part of the disclosed methods and procedures. As will be appreciated by one of skill in the art, the functionality of the program modules may be combined or distributed as desired in various aspects of the disclosure.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, embodiments of the present disclosure should be considered in all respects as illustrative and not restrictive. It will be evident to the annotator skilled in the art to freely combine several or all of the embodiments discussed here as deemed suitable for a specific application of the disclosure. Accordingly, the scope of the disclosure should be determined not by the embodiments illustrated, but by the appended claims and their equivalents.

What is claimed:

1. A method, comprising:
monitoring an automotive computing environment executing a plurality of virtual machines;
responsive to a request to instantiate a new virtual machine, inspecting a configuration file of the new virtual machine;
responsive to a configuration parameter of the configuration file violating a first predefined safety rule, modifying the configuration parameter;
monitoring communications to and from a virtual machine of the plurality of virtual machines, the monitored communications including a first communication; and
responsive to the first communication violating a second predefined safety rule, modifying a parameter of the automotive computing environment, or intercepting the first communication and modifying a content of the first communication.

2. The method of claim 1, wherein the first predefined safety rule is a resource usage limit, an access permission, or a network restriction.

3. The method of claim 1, wherein the configuration parameter is an allocated quantity of memory, a port configuration, an indication of a dependency, or an indication of an access requirement.

4. The method of claim 1, wherein the configuration parameter is compared against a known configuration parameter in a database.

5. The method of claim 1, wherein the second predefined safety rule is a latency limit, a content restriction, or a communication security requirement.

6. The method of claim 1, wherein the parameter of the automotive computing environment is a communication rate limit, a network bandwidth, or a communication encryption setting.

7. The method of claim 1, wherein modifying a content of the first communication comprises removing sensitive data, and wherein the sensitive data comprises at least one of a resource limit, a runtime state, or a geographical position.

8. The method of claim 1, wherein the inspecting is abridged responsive to the new virtual machine being a previously encountered virtual machine.

9. The method of claim 1, further comprising:
training a machine learning model with violations of at least one of the first predefined safety rule or the second predefined safety rule;
employing the machine learning model to predict that a safety rule violation is going to occur; and
based upon the prediction, modifying the configuration parameter, the parameter of the automotive computing environment, or the first communication to prevent the safety rule violation.

10. The method of claim 1, further comprising modifying the first predefined safety rule or the second predefined safety rule responsive to a change in an external environment of the automotive computing environment.

11. The method of claim 1, further comprising:
determining that a cause of a violation is no longer applicable; and
modifying the configuration parameter or the parameter of the automotive computing environment back to an initial state responsive to the determining.

12. The method of claim 1, wherein the new virtual machine and each virtual machine of the plurality of virtual machines is assigned an automotive safety integrity level (ASIL), and wherein the first predefined safety rule or the second predefined safety rule is determined based at least in part upon the ASIL of the new virtual machine or of a virtual machine of the plurality of virtual machines.

13. A system, comprising:
a memory; and
a processing device, operatively coupled to the memory, to:
monitor an automotive computing environment executing a plurality of virtual machines;
responsive to a request to instantiate a new virtual machine, inspect a configuration file of the new virtual machine;
responsive to a configuration parameter of the configuration file violating a first predefined safety rule, modify the configuration parameter;
monitor communications to and from a virtual machine of the plurality of virtual machines, the monitored communications including a first communication; and
responsive to the first communication violating a second predefined safety rule, modify a parameter of the automotive computing environment, or intercept the first communication and modify a content of the first communication.

14. The system of claim 13, wherein the first predefined safety rule is a resource usage limit, an access permission, or a network restriction.

15. The system of claim 13, wherein the configuration parameter is an allocated quantity of memory, a port configuration, an indication of a dependency, or an indication of an access requirement.

16. The system of claim 13, wherein the configuration parameter is compared against a known configuration parameter in a database.

17. The system of claim 13, wherein the second predefined safety rule is a latency limit, a content restriction, or a communication security requirement.

18. The system of claim 13, wherein the parameter of the automotive computing environment is a communication rate limit, a network bandwidth, or a communication encryption setting.

19. The system of claim 13, wherein modifying a content of the first communication comprises removing sensitive data, and wherein the sensitive data comprises at least one of a resource limit, a runtime state, or a geographical position.

20. A non-transitory computer-readable medium storing instructions which, when executed by a processing device, cause the processing device to:
monitor an automotive computing environment executing a plurality of virtual machines;
responsive to a request to instantiate a new virtual machine, inspect a configuration file of the new virtual machine;
responsive to a configuration parameter of the configuration file violating a first predefined safety rule, modify the configuration parameter;
monitor communications to and from a virtual machine of the plurality of virtual machines, the monitored communications including a first communication; and
responsive to the first communication violating a second predefined safety rule, modify a parameter of the automotive computing environment, or intercept the first communication and modify a content of the first communication.
